(19) United States
(12) Patent Application Publication
(10) Pub. No.: US 2017/0169032 A1
(43) Pub. Date: Jun. 15, 2017

(54) METHOD AND SYSTEM OF SELECTING AND ORDERINGCONTENT BASED ON DISTANCE SCORES

(71) Applicant: Hewlett-Packard Development Company, L.P., Houston, TX (US)

(72) Inventors: Joshua Hailpern, Joshua Hailpern, CA (US); Niranjan Damera Venkata, Chennai (IN)

(21) Appl. No.: 15/375,876

(22) Filed: Dec. 12, 2016

(30) Foreign Application Priority Data
Dec. 12, 2015 (IN) 6678/CHE/2015

(51) Int. Cl. G06F 17/30

(52) U.S. Cl. CPC G06F 17/3053; G06F 17/30554

(57) ABSTRACT

An example embodiment of the present techniques extracts sequences of features from each article of a plurality of articles. A background language model may be generated based on the sequences of features extracted from the plurality of articles and a new model can be generated based on sequences of features from a set of selected articles. A comparison between the new language model and language models generated for remaining articles may be performed to generate a distance score for each of the remaining articles. An article may be added to the set of selected articles based on distance score. Content may be returned based on the set of selected articles.

### BACKGROUND

Many situations exist in which a substantial amount of content is related to a particular time frame or subject matter. For example, in automated news collection and distribution, systems automatically crawl websites or receive article feeds. This produces a large volume of news articles over a given time frame. Because these articles can come from various sources that may all use the same author source, often very similar if not identical articles are published. Further, news agencies sometimes update stories as more information comes forward. Lastly, even if the articles themselves are different, many articles can be about the same news event or topic. In addition, automatic creation of textbooks and text book personalization can also be based on a plurality of sources.

### BRIEF DESCRIPTION OF THE DRAWINGS

Certain example embodiments are described in the following detailed description and in reference to the drawings, in which:

FIG. 1 is a block diagram of a system that may select and display content:

FIG. 2 is a process flow diagram showing a method of selecting and ordering content for display;

FIG. 3 is a process flow diagram showing a method of preprocessing articles and extracting sequences of features from each article;

FIG. 4A is a process flow diagram showing a method of detecting identical articles;

FIG. 4B is a process flow diagram showing a method of detecting an extension;

FIG. 4C is a process flow diagram showing a method of detecting a series; and

FIG. 5 is a block diagram showing a non-transitory, tangible computer readable medium that stores code for selecting and displaying content.

### DETAILED DESCRIPTION OF SPECIFIC EMBODIMENTS

Content may be grouped in order to represent a corpus, which can be generally described as a large and structured set of texts corresponding to a plurality of articles. For example, articles include words and/or sentences and can be in the form of documents, audio files, video files, and the like. As used herein, a document refers to a set of sentences. A document can include a single article, a subset of an article, or multiple articles. An article, as used herein, refers to a piece of written text, or text associated with an audio, video, or any other form of media, about a specific topic. A topic, as used herein, refers to the subject matter of an article, such as the topic of a news article. Selecting content to display and the order in which to display the content may be difficult. For example, the amount of effort used in tagging and organizing, or topic modeling, can limit the breadth of information being displayed. Manual effort is also expensive and does not scale very well. Topic modeling is another alternative approach that is both computationally intense and does not scale in large data sets.

Accordingly, some examples described herein provide automatic selection and ordering of content for display from a corpus of content within a particular scope by using distance scores from articles already selected or “seen” by a reader so as to maximize the subject matter they are exposed to. Thus, the techniques herein can be used to find the most widely covered subject matter within a scope to display to a user. For example, the scope of the content can be a particular time frame or subject matter. These techniques may be applied to any corpus of content. For example, audio and video, in addition to text, can be selected for display. Further, a plurality of features may be extracted. A feature, as used herein, refers to an individual measurable property of a phenomenon being observed. For example, a feature can be an N-gram or Named Entity. An N-gram, as used herein, refers to a set of one or more contiguous words that occur in a given series in text. Named Entity Recognition (NER), as used herein, refers to a subtask of information extraction that seeks to locate and classify elements in text into pre-defined categories such as the names of persons, organizations, locations, expressions of times, quantities, monetary values, percentages, etc. Named as used in a Named Entity, as used herein, restricts the task to those entities for which one or many rigid designators stands for a referent. For example, a rigid designator can designate the same thing in all possible worlds in which that thing exists and does not designate anything else in those possible worlds in which that thing does not exist.

Further, an embodiment of the present techniques includes a preprocessing process that can preprocess articles from a corpus for efficient processing. Moreover, embodiments of the present techniques may use distribution comparisons to detect relationships between articles. For example, the present techniques can be used to determine whether a pair of articles are from a series, are identical but may have a different title, and/or whether one article is extension of another. For example, an extension can include an original news article and another copy of that article with an update. Thus, the techniques described herein work extremely fast, scale very well, and are robust to both long and short articles and/or corpus sizes. Thus, computing resources can be saved using the present techniques. The techniques enable the greatest variety of content to be selected and displayed given a limited amount of space or time.

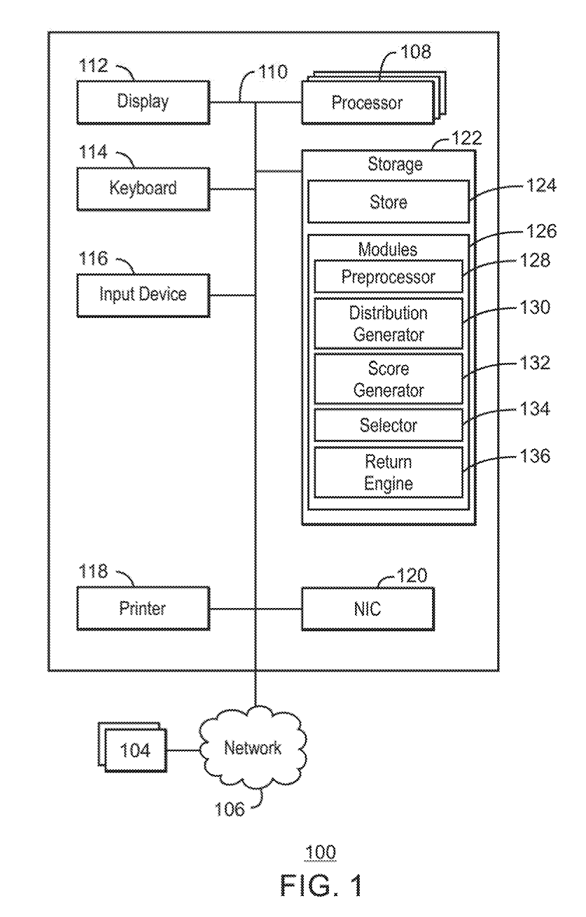

FIG. 1 is a block diagram of a system that may select and display content. The system is generally referred to by the reference number 100.

The system 100 may include a computing device 102, and one or more client computers 104 in communication over a network 106. As used herein, a computing device 102 may include a server, a personal computer, a tablet computer, and the like. As illustrated in FIG. 1, the computing device 102 may include one or more processors 108, which may be connected through a bus 110 to a display 112, a keyboard 114, one or more input devices 116, and an output device, such as a printer 118. The input devices 116 may include devices such as a mouse or touch screen. The processors 108 may include a single core, multiples cores, or a cluster of cores in a cloud computing architecture. The computing device 102 may also be connected through the bus 110 to a network interface card (NIC) 120. The NIC 120 may connect the computing device 102 to the network 106.

The network 106 may be a local area network (LAN), a wide area network (WAN), or another network configuration. The network 106 may include routers, switches, moderns, or any other kind of interface device used for interconnection. The network 106 may connect, to several client computers 104. Through the network 106, several client computers 104 may connect to the computing device 102. Further, the computing device 102 may access texts across network 106. The client computers 104 may be similarly structured as the computing device 102.

The computing device 102 may have other units operatively coupled to the processor 108 through the bus 110. These units may include non-transitory, tangible, machine-readable storage media, such as storage 122. The storage 122 may include any combinations of hard drives, read-only memory (ROM), random access memory (RAM), RAM drives, flash drives, optical drives, cache memory, and the like. The storage 122 may include a store 124, which can include any documents, texts, audio, and video, from, which text is extracted in accordance with an embodiment of the present techniques. Although the store 124 is shown to reside on computing device 102, a person of ordinary skill in the art would appreciate that the store 124 may reside on the computing device 102 or any of the client computers 104.

The storage 122 may include a plurality of modules 126. A preprocessor 128 can extract sequences of features from a plurality of articles. In some examples, the plurality of articles can be filtered based on a scope. For example, the scope can be a time frame and/or a subject matter. For example, a time frame can be the past 24 hours. An example subject matter can be textbook chapters about Mongolian history. The features can include n-grams, named entities, picture types, and media types, among other possible features. A distribution generator 130 can generate a background model including a first probability distribution over all the extracted sequences of features of the plurality of articles. For example, the background model can be a statistical language model. The background language model can account for the overall “noise” of all potential content. The distribution generator 130 can generate an additional probability distribution over the extracted sequences of features for an ordered selected subset of the plurality of articles and an additional probability distribution for each of the unselected articles. For example, the ordered selected subset may be a preselected subset provided by a user. In some examples, the additional probability distributions can be smoothed using the background model. The ordered selected subset can be considered a “seen” distribution, representing content that the reader has already encountered. In order to maximize the variety of seen content, content can be added to the ordered selected subset by maximizing a distance from the “seen” distribution. In some examples, the articles in the ordered selected subset can also be weighted based on the order in which the articles have been seen. Articles seen more recently may have more weight than articles seen in the more distant past. In some examples, if the ordered selected subset is empty, then to determine the ordered selected subset, the distribution generator 130 can perform a comparison between each unique pairing of the plurality of articles to generate a distance score for each unique pairing. For example, the distance score can be a Kullback-Leibler divergence (KL-divergence or KLD) score. The distribution generator 130 can also calculate an average KL-divergence score for each article against all other articles. The distribution generator 130 can further select an article associated with a highest average KL-divergence score. In some examples, the distribution generator 130 can smooth additional probability distributions using the first probability distribution.

A score generator 132 can calculate a distance score for each unselected article as compared to the probability distribution for the ordered selected subset. For example, the score generator can calculate the distance score based on the probability distribution for each unselected article. In some examples, the distance score can be based on KL-divergence. A selector 134 can select an article from the unselected articles based on distance score and add the selected article to the ordered selected subset of articles. For example, the selector can select an article from the unselected articles with the highest distance score. In some examples, a threshold distance range can be used to select articles that are not the same, but close to a given article or set of articles. For example, updates or extensions to a given article may be displayed. A return engine 136 can detect the ordered selected subset exceeds a predetermined threshold number of selected articles. The return engine 136 can return content based on the selected articles in the ordered selected subset In some examples, the selected articles can be displayed, transmitted, stored, or printed in an order in which the selected articles were selected and added to the ordered selected subset. The client computers 104 may include storage similar to storage 122.

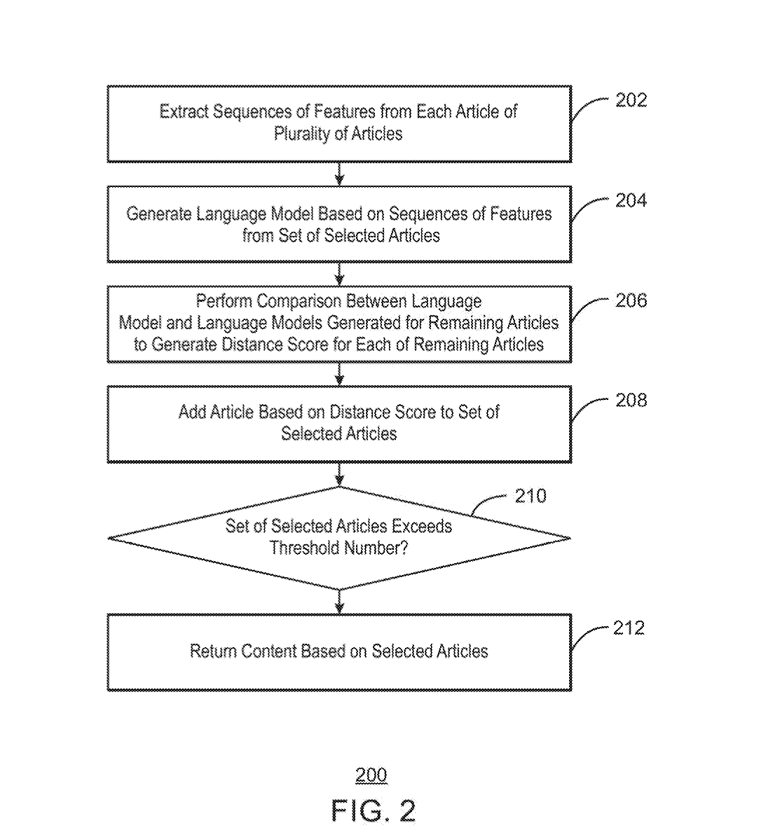

FIG. 2 is a process flow diagram showing a method of selecting and ordering content for display. The example method is generally referred to by the reference number 200 and can be implemented using the processor 108 of the example system 100 of FIG. 1 above.

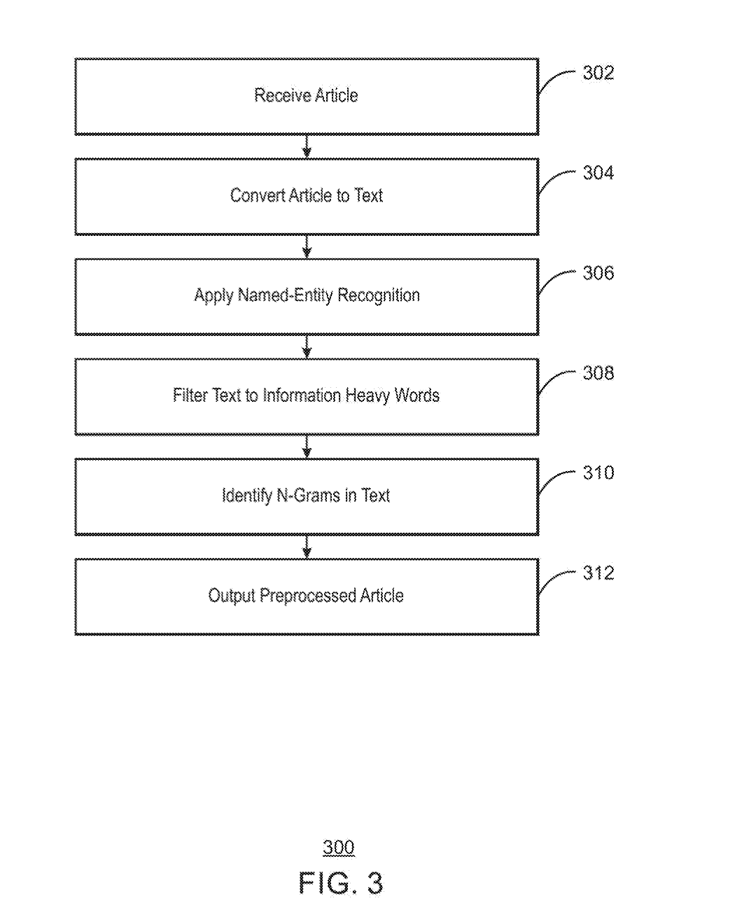

At block 202, the processor ex acts sequences of features from each article of the plurality of articles For example, key words can be determined using standard information retrieval techniques. In some examples, named-entity recognition and n-gram identification techniques can be applied. An information heavy version of each article can thus be generated for each preprocessed article. In some examples, the plurality of articles can be filtered based on scope. For example, the plurality of articles can be documents with text, audio, video, among other forms of media. The scope can be a particular time frame and/or a subject matter area. For example, the scope can be news stories within the past 48 hours. These techniques are described in greater detail with respect to FIG. 3 below.

At block 204, the processor generates a language model based on sequences of features from a set of selected articles. In some examples, the new model can be smoothed based on the background language model. In some examples, the set of selected articles can be a predetermined set of articles that have been selected to be displayed. The set of selected articles can also be ordered. In some examples, if the set of selected articles is empty or not available, then the processor can determine a first article to use in the set of selected articles. For example, a background language model can be used in place of N in the equation (7) below without any normalization that would normally use the background language model. Thus, an article can, be selected that is the most unique as compared to all the other articles. In some examples, the first article can also exceed a predetermined threshold of minimum words to prevent short articles with high distance scores due to brevity from being used as the first article.

In some examples, the language model can be based on KL-divergence (KLD). KLD is generally an information theoretic measure based on the idea that there is a probabilistic distribution of words (and their frequencies) that are ideal and thus should be mimicked. For example, the probabilistic distribution of words may correspond to the full text of an article. In some examples, a Statistical Language Model (SLM) approach can be used to create a model of the full text of an article. For any given portion of an article to be made visible to a reader, KLD can be used to evaluate how closely the model of that article portion matches the ideal model of the entire article. A low KLD implies that the article portion conveys much of the same content. Conversely, a high KLD indicates an article portion conveys different content. In some examples, the value of the KL-Divergence metric at every sentence can be used, as a feature when constructing language models. One benefit of the SLM approach is the ability to smooth the keyword frequencies that are common to the broad subject. For example, Dirichlet Prior Smoothing can be used to normalize words used in a corpus of articles and focus on the vocabulary occurrences that are rare or unique in the context of the broader collection of articles.

For example, let S be the set of all articles in a given day of the week (s₀ . . . s_{g}) in a dataset or corpus. The articles can be scoped with a granularity referred to by sᵢ. For example, the granularity can be a day, a week, a month, or based on a certain subject area, such as sports or business. Consider an example where D is the set of all articles (d₀ . . . d_{b}) in the given scope sᵢ and W is the set of all unique words or N-grams (w₀ . . . wₕ) in sᵢ. The frequency of any given word wⱼ in a given article dₖ can be denoted by f((wⱼ|dₖ). The total count of all words in dₖ can be calculated by the equation:

T(dₖ)=Σⱼ₌₀^{h}f((wⱼ|dₖ) (Eq. 1)

The probability of a given word (wⱼ) in dₖ can be expressed by the equation:

$$p ( {w}_{j} \vert {d}_{k} ) = \frac{f ( {w}_{j} \vert {d}_{k} )}{T ( {d}_{k} )} \qquad ( Eq . 2 )$$

Thus, the probability of a word in an article, using Dirichlet Prior smoothing, can be expressed as:

$$q ( {w}_{j} \vert {d}_{k} ) = \frac{f ( {w}_{j} \vert {d}_{k} ) + μ * p ( {w}_{j} \vert {s}_{i} )}{T ( {d}_{k} ) + μ} \qquad ( Eq . 3 )$$

where p (wⱼ|sᵢ) is the occurrence probability of the word wⱼ in the entire week sᵢ. p (wⱼ|sᵢ) can in turn be calculated using the equation:

$$p ( {w}_{j} \vert {s}_{i} ) = \frac{\sum {d}_{k} ∈ {s}_{i} f ( {w}_{j} \vert {d}_{k} )}{\sum {d}_{k} ∈ {s}_{i} T ( {d}_{k} )} \qquad ( Eq . 4 )$$

The smoothing constant μ can be estimated using the equation:

$$\begin{matrix}{m}_{j} = p ( {w}_{j} \vert {s}_{i} ) & ( Eq . 5.1 ) \\ {B}_{j} = {\sum }_{{d}_{k} ∈ {s}_{i}} ( {( \frac{f ( {w}_{j} \vert {d}_{k} )}{T ( {d}_{k} )} - {m}_{j} )}^{2} ) & ( Eq . 5.2 ) \\ μ = \frac{{\sum }_{{w}_{j} ∈ W} \frac{{B}_{j}}{{m}_{j * ( 1 - {m}_{j} )}}}{{\sum }_{{w}_{j} ∈ W} \frac{{B}_{j}^{2}}{{m}_{j}^{2} * {( 1 - {m}_{j} )}^{2}}} & ( Eq . 5.3 )\end{matrix}$$

Thus, a background language model can be defined as p(wⱼ|sᵢ), or the distribution of word frequencies across all documents in the collection drawn from in sᵢ. Using the background language model as a reference point, the words used in each article can be functionally normalized. A focus can be, placed on vocabulary occurrences that are rare or unique as compared to the background language model.

Given a subset N of selected articles, a new language model can be created for all the selected articles. For example, the selected articles can be articles that have already been previously seen or previously chosen to be in a ranking. The probability of a word in N, using Dirichlet Prior smoothing, can be given by:

$$q ( {w}_{j} \vert N ) = \frac{f ( {w}_{j} \vert N ) + μ * p ( {w}_{j} \vert {s}_{i} )}{T ( N ) + μ} \qquad ( Eq . 6 )$$

At block 206, the processor performs a comparison between the language model and language models generated for the remaining articles to generate a distance score for each of the remaining articles. For example, a test language model can be generated for each remaining article. In some examples, each test SLM corresponding to a remaining article can be compared to the newest background language model. For example, to compare each successive test SLM, the following KL-divergence metric can be used:

$$KLDivergence = {Σ}_{{w}_{j} ∈ N} ( ln ( \frac{q ( {w}_{j} \vert N )}{q ( {w}_{j} \vert {d}_{k} )} ) ) * q ( {w}_{j} \vert N ) \qquad ( Eq . 7 )$$

wherein a smaller KLD metric indicates a closer match and a larger KLD metric indicates the models are further apart. Thus, for each article a KLD score can be calculated as compared to the background language model.

In some examples, Singular Value Decomposition (SVD) can be used for calculating keyword novelty. For example, not all keywords after pre-processing are equally relevant to an article in question. Thus, the order in which a keyword is seen can directly impact how much value the keyword imparts. SVD is generally able to filter out noisy aspect of relatively small or sparse data and often used for dimensionality reduction. To calculate word weight using SVD, each sentence of an article can be represented as a row in a sentence-word occurrence matrix encompassing m sentences and n unique words, referred to herein as M. The sentence-word occurrence matrix M can be constructed in O(m). SVD can decompose the m×n matrix M into a product of three matrices: M=UΣV*. Σ is a diagonal matrix whose values on the diagonal, referred to as σᵢ, are the singular values of M. By identifying the four largest σᵢ values, referred to as λ₁-λ₄, we are able to take the corresponding top eigenvector columns of V, which is the conjugate transpose of V*, which we refer to as ε₁-ε₄. Each entry in each of these vectors ε₁-ε₄ corresponds to a unique word in M. Then, a master eigenvector ε′ can be calculated as the weighted average of ε₁-ε₄, weighted by λ₁-λ₄, using the equation:

$${ɛ}^{′} = \frac{1}{4} {\sum }_{i = 1}^{4} {λ}_{i} {ɛ}_{i} \qquad ( Eq . 8 )$$

Thus, ε′ is a vector in which each entry represents a unique word, and the value of ε′ can be interpreted as the ‘centrality’ of the word to the given article. Once the keyword weights are calculated, the keyword weights can be used when summing up the total value for a given word distribution when performing KLD calculations.

At block 208, the processor adds an article based on distance score to the set of selected articles. For example, the processor can select an article from the unselected articles with the highest distance score. As mentioned above, the article with the largest KLD score can indicate the largest difference to the set of selected articles. The article with the highest KLD score may thus have the most new content. Therefore, in some cases, the article with the highest KLD score can be added to the set of selected articles. In some examples, if two or more scores are among the highest KLD scores, then the articles can further be weighted based on reputation. For example, a reputation factor can be introduced into the KLD calculation at block 206 above, in some examples, a ranking comparison can be used. For example, if two articles have the same KLD score within a predetermined number of points, then the article from the most reputable author or publisher can be chosen based on a reputation score. In some examples, a threshold distance range can be used to select articles that are not the same, but close to a given article or set of articles. For example, the processor may cause updates or extensions to a given article to be displayed.

At block 210, the processor determines whether a set of selected articles exceeds threshold number. If the processor detects that the number of articles in the set of selected articles exceeds a threshold number then the method may proceed at block 214. If the processor detects that the number of articles in the set of selected articles does not exceed the threshold number then the method may proceed at block 206. Thus, in some examples, once an article is added to the set of selected articles, the background language model can be updated and additional ILD scores calculated to select additional articles to add to the set of selected articles. For example, once an article is selected and added to the set of articles N, the processor can recalculate q(wⱼ|N) at block 206 and resume the method at block 208.

At block 212, the processor returns content based on the set of selected articles. The processor can display content based on an order that articles were added to the set of selected articles. For example, a composite text can be displayed based on the ordered set of selected articles. In some examples, extracted text from audio and/or video can be used as an article, thereby allowing the audio/video to be played back rather than displaying raw text, based on the ordered set of selected articles.

This process flow diagram is not intended to indicate that the blocks of the example method 200 are, to be executed in any particular order, or that all of the blocks are to be included in every case. Further, any number of additional blocks not shown may be included within the example method 200, depending on the details of the specific implementation. For example, multiple background models can be used. In some examples, a background model can be generated for a section of a document, the document as a whole or the current corpus, and a previously selected article corpus.

FIG. 3 is a process flow diagram showing a method 300 of preprocessing articles and extracting sequences of features from each article. The example method is generally referred to by the reference number 300 and can be implemented using the processor 108 of the example system 100 of FIG. 1 above.

At block 302 the processor receives an article. For example, the article can be part of a document, audio, video, among other media.

At block 304, the processor converts the article to text. For example, audio files can be converted using automated speech to text detection techniques. The audio in any video files can be similarly converted to text.

At block 306, the processor applies named-entity recognition. For example, the processor can locate and classify elements into different n-grams that related to the same entity. For Example, “Obama”, “Barak Obama” and “President Obama” are all in reference to the same, entity, and thus every occurrence can be treated as identical. These entities can be pre-defined, or be detected algorithmically. In some examples, named-entity resolution can be used to weight named people and places higher.

At block 388, the processor filters text to information heavy words. The processor can limit text to information heavy words using standard information retrieval (IR) techniques. For example, the processor can limit text to nouns. In some examples, the processor may also remove any pluralization through lemmatization. For example, different inflected forms of a word can be group together to be analyzed as a single item.

At block 310, the processor identifies N-Grams in the text. As discussed above, an n-gram can be any set of n contiguous words in a text. For example, in the phrase “New York City,” a 1-gram (unigram) can be “New”, a 2-gram (bigram) can be “New York”, and a 3-gram (trigram) can be “New York City.” Determining how long a phrase is, and thus the value of n, can be done through any appropriate well-established algorithmic approach.

At block 312, the processor outputs a preprocessed article. For example, the preprocessed article may contain information-heavy text such as keywords.

This process flow diagram is not intended to indicate that the blocks of the example method 300 are to be executed in any particular order, or that all of the blocks are to be included in every case. Further, any number of additional blocks not shown may be included within the example method 300, depending on the details of the specific implementation.

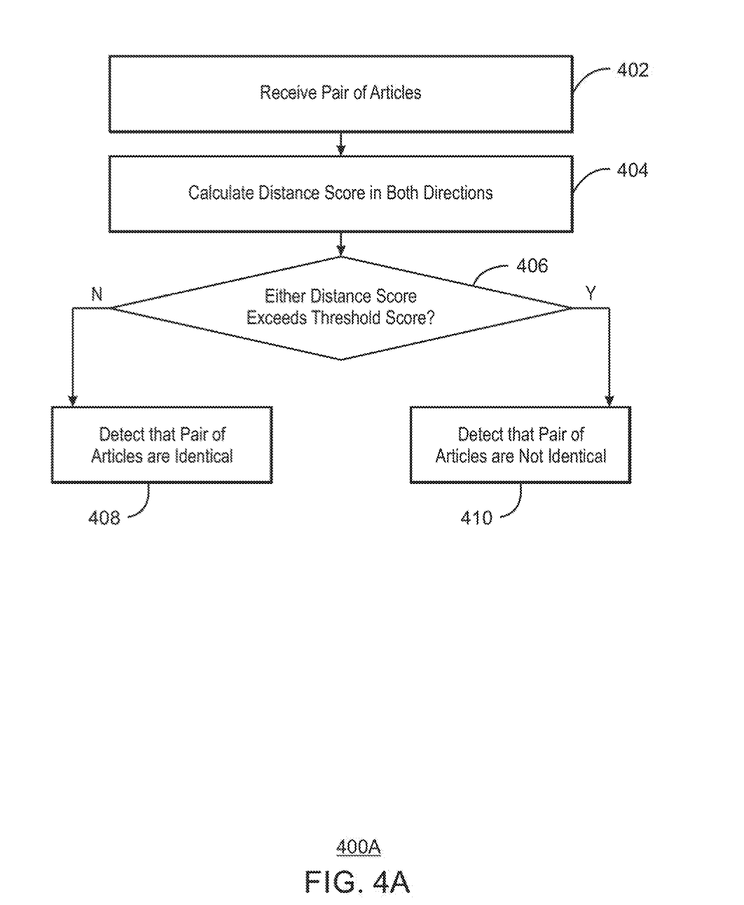

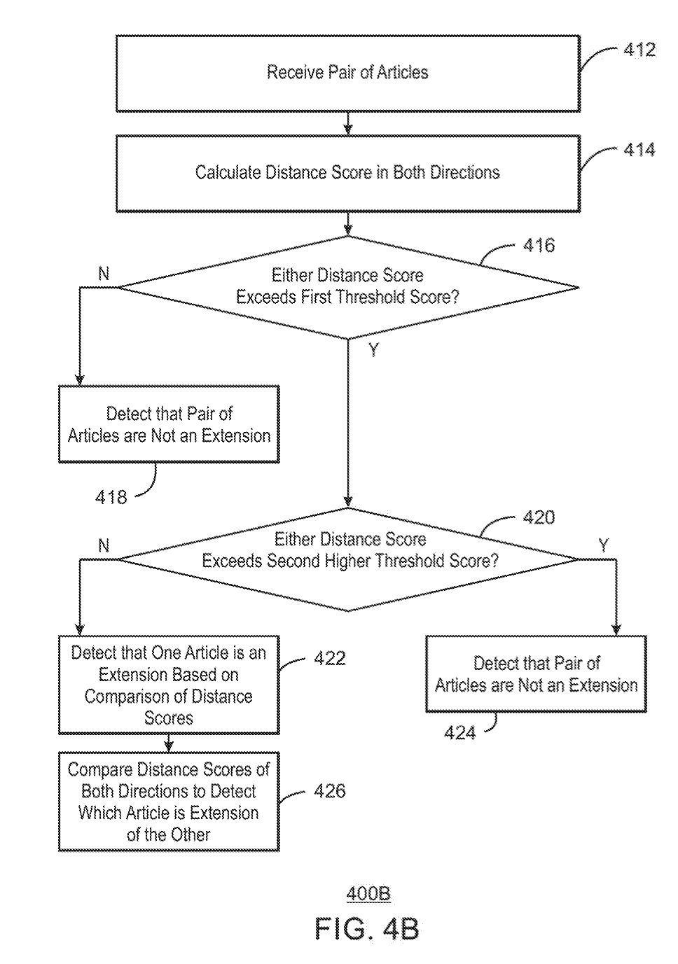

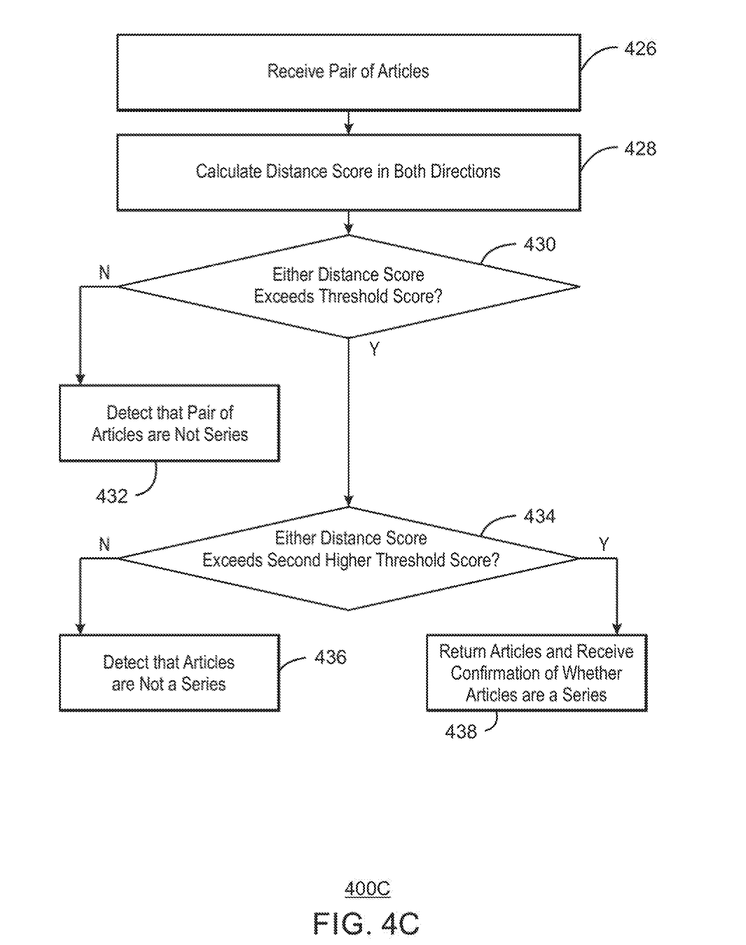

FIG. 4A is a process flow diagram showing a method of detecting identical articles. The example method is generally referred to by the reference number 400A and can be implemented using the processor 10 of the example system 100 of FIG. 1 above.

At block 402, the processor receives a pair of articles. In some examples, the articles may have been preprocessed according to the techniques of FIG. 3 above.

At block 404, the processor calculates a distance score in both directions. For example, the distance score, can be a KL-Divergence (KLD) score. The processor can calculate the KLD score using the Equation 7 above, with one article compared as N and the second article compared as dₖ in Equation 7. Then, the first article can be compared as dₖ and the second article can be compared as N in Equation 7.

At block 406, the processor determines whether either the distance, score exceeds a threshold score. If the processor detects that either KLD score exceeds a threshold score, then the method may proceed at block 410. If the processor detects that neither KLD score exceeds a threshold score, then the method may proceed at block 408. In some examples, the threshold score can be close to zero.

At block 408, the processor detects that the pair of articles are identical. For example, because the KLD score in both directions did not exceed the threshold, this may be a strong indication of a close match In some examples, the processor can remove an article of the pair of articles from the plurality of articles based on lower average distances score.

At block 410, the processor detects that the pair of articles are not identical. For example, because at least one direction indicates a different between the language models corresponding to the two articles, this may be a strong indication that the articles differ.

This process flow diagram is not intended to indicate that the blocks of the example method 400A are to be executed in, any particular order, or that, all of the blocks are to be included in every case. Further, any number of additional blocks not shown may be included within the example method 400, depending on the details of the specific implementation.

FIG. 4B is a process flow diagram showing a method, of detecting an extension. The example method is generally referred to by the reference number 400B and can be implemented using the processor 108 of the example system 100 of FIG. 1 above.

At block 412, the processor receives pair of articles. In some examples, the articles may have been preprocessed according to the techniques of FIG. 3 above.

At block 414, the processor calculates a distance score in both directions. For example, the processor can calculate the KLD score using the Equation 7 above, with one article compared as N and the second article compared as dₖ in Equation 7. Then, the first article can be compared as dₖ and the second article can be compared as N in Equation 7.

At block 416, the processor determines whether either distance score exceeds a first threshold score. If the processor detects that either KLD score exceeds a threshold score, then the method may proceed at block 420. If the processor detects that neither KLD score exceeds a threshold score, then the method may proceed at block 418.

At block 418, the processor detects that pair of articles are not an extension. For example, the articles may be so close that the articles should be considered identical rather than an extension.

At block 420, the processor determines whether either distance score exceeds a second higher threshold score. If the processor detects that either KLD score exceeds a second threshold score, then the method may proceed at block 424. If the processor detects that neither KLD score exceeds the second threshold score, then the method may proceed at block 422.

At block 422, the processor detects that one article is an extension based on comparison of distance scores. For example, since the articles have KLD scores that exceed the first threshold but do not exceed the second threshold, the articles are closely related but not identical. Thus, an article may have been written and then later updated via an extension article.

At block 424, the processor detects that pair of articles are not an extension. For example, the KLD score in at least one direction may indicate that the pair of articles are not related closely enough to be considered extensions of the same article.

At block 426, the processor compares distance scores of both directions to detect which article is an extension of the other. For example, when the extension is the ideal SLM, the relationship will have a smaller KLD than when the original is the ideal. Thus, the directionality of the KLD scores can be used to identify which of the closely related, articles is an extension of the other. In some examples, the processor can remove the article that is not an extension of the other article.

This process flow diagram is not intended to indicate that the blocks of the example method 400B are to be executed in any particular order, or that all of the blocks are to be included in every case. Further, any number of additional blocks not shown may be included within the example method 400B, depending on the details of the specific implementation.

FIG. 4C is a process flow diagram showing a method of detecting a series. The example method is generally referred to by the reference number 400C and can be implemented using the processor 108 of the example system 100 of FIG. 1 above.

At block 426, the processor receives a pair of articles. In some examples, the articles may have been preprocessed according to the techniques of FIG. 3 above.

At block 428, the processor calculates a distance score in both directions. For example, the processor can calculate a KLD score using the Equation 7 above, with one article compared as N and the second article compared as dₖ in Equation 7. Then, the first article can be compared as dₖ and the second article can be compared as N in Equation 7.

At block 430, the processor determines whether either distance score exceeds a threshold score. If the processor detects that either KLD score exceeds a threshold score, then the method may proceed at block 434. If the processor detects that neither KLD score exceeds a threshold score, then the method may proceed at block 432. In some examples, the threshold score can be close to zero.

At block 432, the processor detect that pair of articles are not series. For example, the low KLD scores may indicate that the pair of articles are identical rather than part of a series.

At block 434, the processor determines whether either distance score exceeds a second higher threshold score. If the processor detects that either KLD score exceeds the second threshold score, then the method may proceed at, block 438. If the processor detects that neither KLD score exceeds the second threshold score, then the method may proceed at block 434. In some examples, the second threshold score can be higher than the first threshold but lower than a score indicating that the pair of articles are not related.

At block 436, the processor detects that the pair of articles are not part of a series. For example, because neither KLD score exceeds the second threshold, the pair is more likely to be an extension rather than a series.

At block 438, the processor displays articles and receive confirmation of whether articles are part of a series. For example, the processor can send a notification that two articles have been tagged as a potential series of articles. The processor may then receive a confirmation that the two articles are indeed part of a series and labeled accordingly. In some examples, the processor may receive an indication that the two articles are not part of a series. The processor may then remove the tag.

This process flow diagram is not intended to indicate that the blocks of the example method 400C are to be executed in any particular order, or that all of the blocks are to be included in every case. Further, any number of additional blocks not shown may be included within the example method 400C, depending on the details of the specific implementation.

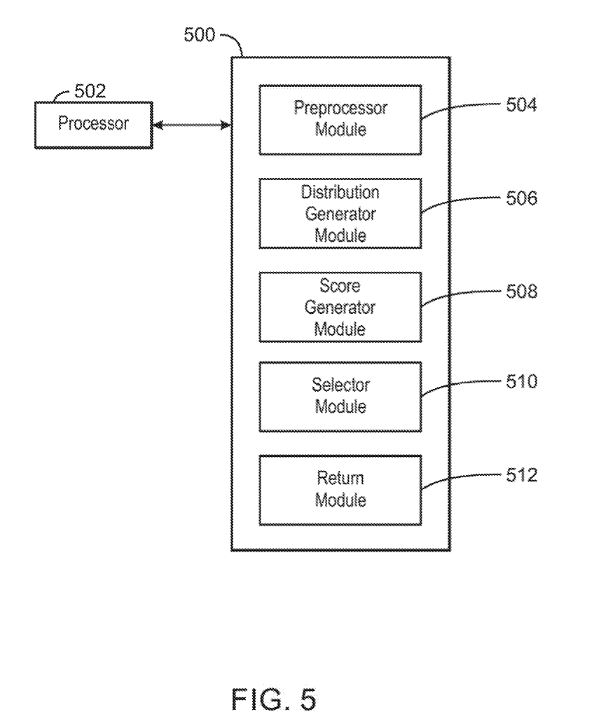

FIG. 5 is a block diagram showing a non-transitory, tangible computer-readable medium that stores code for selecting and displaying content. The non-transitory, tangible computer-readable medium is generally referred to by the reference number 500.

The non-transitory, tangible computer-readable medium 500 may correspond to any typical storage device that stores computer-implemented instructions, such as programming code or the like. For example, the non-transitory, tangible computer-readable medium 500 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 502 generally retrieves and executes the computer-implemented instructions stored in the non-transitory, tangible computer-readable medium 500 for extracting concepts and relationships from texts. A preprocessor module 504 can extract sequences of features from a plurality of articles filtered based on a scope. For example, the scope can be a time frame and/or a subject matter. In some examples, the preprocessor module 504 can also weight articles based on reputation. In some examples, the preprocessor module 504 can weight articles based on received past preferences. A distribution generator module 506 can generate language models. For example, the distribution generator module 506 can generate a first probability distribution over the sequences of features of the plurality of articles. The distribution generator module 506 can also generate additional probability distribution for a selected subset of the plurality of articles and for each unselected article. In some examples, the distribution generator module 506 can smooth additional probability distributions using the first probability distribution. For example, the first probability distribution can be a background language model. A score generator module 508 can calculate distance scores. For example, the score generator module 508 can calculate a distance score for the unselected articles based on the additional probability distribution for each unselected article as compared to the additional probability distribution for the selected subset. The selector module 510 can select an article from the unselected articles based on distance score and add the article to the selected subset of articles. For example, the selector module 510 can select an article from the unselected articles with a highest distance score. In some examples, the selector module 510 can select articles that are not the same, but dose to a given article or set of articles based on a threshold distance range. For example, updates or extensions to a given article may be displayed. In some examples, the ordered selected subset of articles can be a provided ordered subset of articles. In some examples, the score generator module 508 can generate a selected subset of articles. For example, the score generator module 508 can perform a comparison between each unique pairing of the plurality of articles to generate a KL-divergence score for each unique pairing. The score generator module 508 can then calculate an average KL-divergence score for each article against all other articles. A selector module 510 can select an article associated with a highest average KL-divergence score. Thus, the selector module 510 can determine a first article to populate an empty subset if an ordered subset is not provided or available. For example, the selector module 510 select an article associated with a highest average distance score to generate the ordered selected subset. The selector module 510 can then select an article from the unselected articles based on distance score and add the article to the selected subset of articles. For example, the selector module 510 can select an article with a highest distance score as compared to the ordered subset of articles. A return module 512 can return content based on the selected subset. For example, the selected subset can be displayed, transmitted, stored, and/or printed based on an order in which articles were added to the selected subset.

In some examples, the selector module 510 can further include code to detect various relationships between pairs of articles. For example, the selector module 510 can include code to detect a pair of articles are identical based on a KL-divergence score below a threshold KL-divergence score in both directions. The selector module 510 can also include code to remove an article of the pair of articles from the plurality of articles based on lower average KL-divergence score. In some examples, the selector module 510 can include code to detect a pair of articles have a KL-divergence score exceeding a threshold KL-divergence score in at least one direction. The selector module 510 can also include code to detect that one, of the articles is an extension of a second article in the pair of articles based on, a comparison of the KL -divergence scores calculated in two directions. The selector module 510 can also include code to remove the other article from the plurality of articles. In some examples, the selector module 510 can also include code to detect a pair of articles have a KL-divergence score that exceeds a first threshold KL-divergence score and lower than a second threshold KL-divergence score. The selector module 510 can also include code to display the pair of articles as a potential series of articles. The selector module 510 can include code to receive input confirming or denying the series of articles.

Although shown as contiguous blocks, the software components can be stored in any order or configuration. For example, if the computer-readable medium 500 is a hard drive, the software components can be stored in non-contiguous, or even overlapping, sectors.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed:

1. A system for selecting and ordering content to display from a plurality of articles, comprising:
a preprocessor to extract sequences of features from a plurality of articles;
a distribution generator to generate a probability distribution over extracted sequences of features for an ordered selected subset of the plurality of articles and an additional probability distribution for each of the unselected articles;
a score generator to calculate a distance score for each unselected article as compared to the probability distribution for the ordered selected subset;
a selector to select an article from the unselected articles based on distance score and add the article to the selected subset of articles; and
a return engine to return content based on the articles in the ordered selected subset.

2. The system of claim 1, wherein the distribution generator is to further generate a background model comprising a probability distribution over extracted sequences of features of a plurality of articles, wherein the distribution generator is to smooth the probability distributions using the background model.

3. The system of claim 1, wherein the article from the unselected articles comprises an article with a distance score within a threshold distance range.

4. The system of claim 1, wherein the ordered selected subset of articles comprises a received preselected subset.

5. The system of claim 1, wherein the distribution generator is to further:
perform a comparison between each unique pairing of the plurality of articles to generate a distance score for each unique pairing;
calculate an average distance score for each article against all other articles; and
select an article associated with a highest average distance score to generate the ordered selected subset.

6. The system of claim 1, wherein the probability distribution and the additional probability distributions comprise statistical language models.

7. The system of claim 1, wherein the distance score is based on KL-Divergence.

8. A method for selecting and ordering content, comprising:
extracting sequences of features each article of a plurality of articles;
generating a language model based on sequences of features from a set of selected articles;
performing a comparison between the language model and language models generated for remaining articles to generate a distance score for each of the remaining articles;
adding an article based on distance score to the set of selected articles; and
returning content based on the set of selected articles.

9. The method of claim 8, further comprising, if the set f selected articles is empty:
performing comparison between each unique pairing of articles to determine a distance score for each unique pairing;
calculating an average distance score for each article against all other articles; and
generating the language model based on the article with a highest average distance score.

10. The method of claim 8, wherein displaying content based on the selected articles is based on an order that articles were added to the set of selected articles.

11. The method of claim 8, further comprising:
detecting a pair of articles have a distance score below a threshold distance score in both directions; and
removing an article of the pair of articles from the plurality of articles based on lower average distance score.

12. The method of claim 8, further comprising:
detecting a pair of articles have a distance score exceeding a threshold distance score in at least one direction;
detecting that one of the articles is an extension of a second article in the pair of articles based on a comparison of distance scores calculated in two directions; and
removing the second article from the plurality of articles.

13. The method of claim 8, further comprising,
detecting a pair of articles have a distance score that exceeds a first threshold distance score and lower than a second threshold distance score; and
displaying the pair of articles as a potential series of articles.

14. A non-transitory, tangible computer-readable medium, comprising code to direct a processor to:
extract sequences of features from a plurality of articles filtered based on a scope;
generate a first probability distribution over the sequences of features of the plurality of articles;
generate an additional probability distribution for a selected subset of the plurality of articles and for each unselected article, wherein the additional probability distributions are smoothed using the first probability distribution;
calculate a distance score based on the additional probability distribution for each unselected article as compared to the probability distribution for the selected subset;
select an article from the unselected articles based on distance score and add the article to the selected subset of articles; and
return content based on the selected subset.

15. The non-transitory, tangible computer-readable medium of claim 14, further comprising code to direct the processor to:
perform a comparison between each unique pairing of the plurality of articles to generate a distance score for each unique pairing;
calculate an average distance score for each article against all other articles; and
select an article associated with a highest average distance score.

16. The non-transitory, tangible computer-readable medium of claim 14, further comprising code to direct the processor to weight articles based on reputation.

17. The non-transitory, tangible computer-readable medium of claim 14, further comprising code to direct the processor to weight articles based on received past preferences.

18. The non-transitory, tangible computer-readable medium of claim 14, further comprising code to direct the processor to:
detect a pair of articles are identical based on a distance score below a threshold distance score in both directions; and
remove an article of the pair of articles from the plurality of articles fused on lower average distance score.

19. The non-transitory, tangible computer-readable medium of claim 14, further comprising code to direct the processor to:
detect a pair of articles have a distance score exceeding a threshold distance score in at least one direction;
detect that one of the articles is an extension of a second article in the pair of articles based on a comparison of distance scores calculated in two directions; and
remove the other article from the plurality of articles.

20. The non-transitory, tangible computer-readable medium of clam 14, further comprising code to direct the processor to:
detect a pair of articles have a distance score that exceeds a first threshold distance score and lower than a second threshold distance score; and
display the pair of articles as a potential series of articles.
